(19) United States
(12) Patent Application Publication
(10) Pub. No.: US 2020/0142950 A1
(43) Pub. Date: May 7, 2020

(54) METHOD AND SYSTEM OF DEVELOPING STATISTICAL MODEL

(71) Applicant: NANYA TECHNOLOGY CORPORATION, New Taipei City (TW)

(72) Inventor: Jei-Cheng HUANG, NEW TAIPEI CITY (TW)

(21) Appl. No.: 16/180,655

(22) Filed: Nov. 5, 2018

(51) Int. Cl. G06F 17/18; G06F 17/50

(52) U.S. Cl. CPC G06F 17/18; G06F 17/5036

(57) ABSTRACT

The present disclosure provides a method of developing a statistical model for circuit simulation. The method includes: receiving a corner model; receiving a selected dimension of a transistor; and generating a statistical model of the selected dimension based on the corner model.

### TECHNICAL FIELD

The present disclosure relates to a method of developing a statistical model, and more particularly, to a method of developing a statistical model for circuit simulation.

### DISCUSSION OF THE BACKGROUND

Semiconductor device models, such as transistor models, are vital in achieving reliable performance from circuit designs using semiconductor devices. Moreover, semiconductor device models can significantly increase the efficiency of the circuit design process. As such, it is desirable to increase the accuracy of such semiconductor device models.

This Discussion of the Background section is for background information only. The statements in this Discussion of the Background are not an admission that the subject matter disclosed in this section constitutes a prior art to the present disclosure, and no part of this section may be used as an admission that any part of this application, including this Discussion of the Background section, constitutes prior art to the present disclosure.

### SUMMARY

One aspect of the present disclosure provides a method. The method includes receiving a corner model; receiving a selected dimension of a transistor; and generating a statistical model of the selected dimension based on the corner model.

In some embodiments, the corner model includes a typical relationship between a value of an electrical parameter and the selected dimension at a typical corner. The method further includes providing a typical value of an electrical parameter by applying the selected dimension to the typical relationship; and providing a plurality of fake values by applying the typical value to a normal distribution. The generation of the statistical model includes generating the statistical model based on the typical value and the plurality of fake values.

In some embodiments, the corner model further includes a first relationship between a value of an electrical parameter and the selected dimension at a first corner, and a second relationship between a value of an electrical parameter and the selected dimension at a second corner. The method further includes: providing a first corner value by applying the selected dimension to the first relationship; and providing a second corner value by applying the selected dimension to the second relationship. The generation of the plurality of fake values includes generating the plurality of fake values based on the typical value, the first corner value and the second corner value.

In some embodiments, the plurality of fake values is between the first corner value and the second corner value.

In some embodiments, the method further includes setting the typical value as a center value of the normal distribution; setting the first corner value as an upper limit value of the normal distribution; and setting the second corner value as a lower limit value of the normal distribution. The generation of the plurality of fake values includes: generating the plurality of fake values based on the upper limit value, the lower limit value and the center value.

In some embodiments, the method further includes receiving a predetermined quantity of the plurality of fake values. The generation of the plurality of fake values includes generating the plurality of fake values based on the upper limit value, the lower limit value, the center value and the predetermined quantity.

In some embodiments, the typical corner includes a typical-to-typical corner, the first corner includes a slow-to-slow corner, and the second corner includes a fast-to-fast corner.

Another embodiment of the present disclosure provides a system for developing a statistical model for circuit simulation. The system includes one or more processing units. The one or more processing units are configured for: receiving a corner model; receiving a selected dimension of a transistor; and generating a statistical model of the selected dimension based on the corner model.

In some embodiments, the corner model includes a typical relationship between a value of an electrical parameter and the selected dimension at a typical corner. The one or more processing units are further configured for: providing a typical value of an electrical parameter by applying the selected dimension to the typical relationship; providing a plurality of fake values by applying the typical value to a normal distribution, and generating the statistical model based on the typical value and the plurality of fake values.

In some embodiments, the corner model further includes a first relationship between a value of an electrical parameter and the selected dimension at a first corner, and a second relationship between a value of an electrical parameter and the selected dimension at a second corner. The one or more processing units are further configured for: providing a first corner value by applying the selected dimension to the first relationship; providing a second corner value by applying the selected dimension to the second relationship; and generating the plurality of fake values based on the typical value, the first corner value and the second corner value.

In some embodiments, the plurality of fake values are between the first corner value and the second corner value.

In some embodiments, the one or more processing units are further configured for: setting the typical value as a center value of the normal distribution; setting the first corner value as an upper limit value of the normal distribution; setting the second corner value as a lower limit value of the normal distribution; and generating the plurality of fake values based on the upper limit value, the lower limit value and the center value.

In some embodiments, the one or more processing units are further configured for: receiving a predetermined quantity of the plurality of fake values; and generating the plurality of fake values based on the upper limit value, the lower limit value, the center value and the predetermined quantity.

In some embodiments, the typical corner includes a typical-to-typical corner, the first corner includes a slow-to-slow corner, and the second corner includes a fast-to-fast corner.

Another embodiment of the present disclosure provides an article of manufacture. The article of manufacture includes at least one non-transitory machine-readable storage medium having computer readable program code logic tangibly embodied therein to execute a machine instruction in a processing unit for developing a statistical model for a circuit simulation. The computer readable program code logic, when executing, performing the following steps: receiving a corner model; receiving a selected dimension of a transistor; and generating a statistical model of the selected dimension based on the corner model.

In some embodiments, the corner model includes a typical relationship between a value of an electrical parameter and the selected dimension at a typical corner, and the computer readable program code logic, when executing, further performs the following steps: providing a typical value of an electrical parameter by applying the selected dimension to the typical relationship; providing a plurality of fake values by applying the typical value to a normal distribution; and generating the statistical model based on the typical value and the plurality of fake values.

In some embodiments, the corner model further includes a first relationship between a value of an electrical parameter and the selected dimension at a first corner, and a second relationship between a value of an electrical parameter and the selected dimension at a second corner. The computer readable program code logic, when executing, further performs the following steps: providing a first corner value by applying the selected dimension to the first relationship; providing a second corner value by applying the selected dimension to the second relationship; and generating the plurality of fake values based on the typical value, the first corner value and the second corner value.

In some embodiments, the plurality of fake values are between the first corner value and the second corner value.

In some embodiments, the computer readable program code logic, when executing, further performs the following steps: setting the typical value as a center value of the normal distribution; setting the first corner value as an upper limit value of the normal distribution; setting the second corner value as a lower limit value of the normal distribution; and generating the plurality of fake values based on the upper limit value, the lower limit value and the center value.

In some embodiments, the computer readable program code logic, when executing, further performs the following steps: receiving a predetermined quantity of the plurality of fake values; and generating the plurality of fake values based on the upper limit value, the lower limit value, the center value and the predetermined quantity.

In the present disclosure, since the statistical model is developed based on the corner model which is used in a circuit simulation by a circuit designer, the statistical model based on the corner model is relatively reliable and acceptable for a circuit designer. Moreover, it is no longer required to perform measurement to obtain a plurality of process parameters. As a result, it is time efficient.

The foregoing has outlined rather broadly the features and technical advantages of the present disclosure in order that the detailed description of the disclosure that follows may be better understood. Additional features and technical advantages of the disclosure are described hereinafter, and form the subject of the claims of the disclosure. It should be appreciated by those skilled in the art that the concepts and specific embodiments disclosed may be utilized as a basis for modifying or designing other structures, or processes, for carrying out the purposes of the present disclosure. It should also be realized by those skilled in the art that such equivalent constructions do not depart from the spirit or scope of the disclosure as set forth in the appended claims.

### BRIEF DESCRIPTION OF THE DRAWINGS

A more complete understanding of the present disclosure may be derived by referring to the detailed description and claims. The disclosure should also be understood to be connected to the figures' reference numbers, which refer to similar elements throughout the description.

FIG. 1 is a schematic diagram illustrating a design flow of an integrated circuit (IC), in accordance with some embodiments.

FIG. 2 is a schematic diagram of a comparative computing device for generating a statistical model based on measurements of process parameters in wafer fabrication.

FIG. 3 is a schematic diagram illustrating variation in process parameters mentioned in the exemplary example of FIG. 2.

FIG. 4 is schematic diagram of a processing device for developing a statistical model, in accordance with some embodiments of the present disclosure.

FIG. 5 is a flowchart of a method, in accordance with some embodiments of the present disclosure.

FIG. 6 is a flowchart of operation shown in FIG. 5, in accordance with some embodiments of the present disclosure.

FIG. 7 is a schematic diagram illustrating a relationship between a threshold voltage and a length of a transistor at different corners, in accordance with some embodiments of the present disclosure.

FIG. 8 is a schematic diagram of a normal distribution for generating a plurality of fake values, in accordance with some embodiments of the present disclosure.

FIG. 9 is a block diagram of the processing device of FIG. 4 in accordance with some embodiments of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer usable program code embodied in the medium.

Any combination of one or more computer usable or computer readable medium(s) may be utilized. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an internet service provider).

The present disclosure is described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

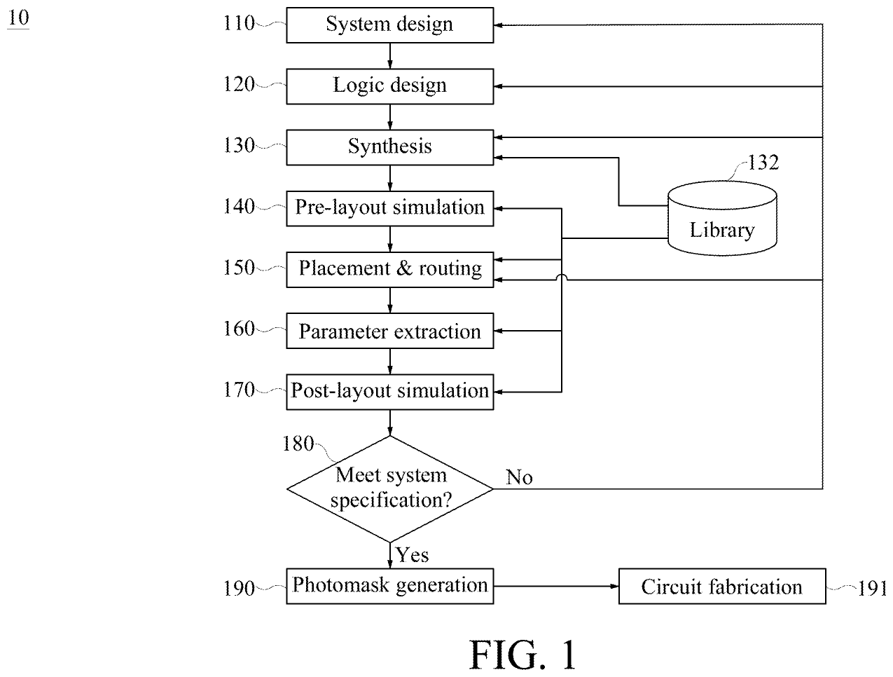

FIG. 1 is a schematic diagram illustrating a design flow 10 of an integrated circuit (IC), in accordance with some embodiments. The design flow 10, employed for designing semiconductor ICs or chips, utilizes one or more electronic design automation (EDA) tools to perform operations therein. A workstation or personal computer is typically used in executing the tools to accomplish the design flow 10. The design flow 10 includes a system design stage 110, a logic design stage 120, a synthesis stage 130, a pre-layout simulation stage 140, a placement and routing development stage 150, a parameter extraction stage 160, a post-layout simulation stage 170, a photomask generation stage 190 and a circuit fabrication stage 191.

Initially, at the system design stage 110, a systematic architecture for the chip of interest is provided with a high-level description. During the system design stage 110, the chip functions along with performance requirements are determined according to a design specification. The chip functions are usually represented by respective schematic functional modules or blocks. In addition, an optimization or performance trade-off may be sought to achieve the design specification at acceptable levels of cost and power.

At the logic design stage 120, the functional modules or blocks are described in a register transfer level (RTL) using a hardware description language. Commercially available language tools are generally used, such as Verilog or VHDL. In an embodiment, a preliminary functionality check is performed during the logic design stage 120 to verify if the implemented functions conform to the specification set forth in the system design stage 110.

Subsequently, at the synthesis stage 130, the modules in the RTL descriptions are converted into an instance of design data, e.g., netlist data, where the circuit structure, e.g., logic gates and registers, of each function module are established. In an embodiment, a standard cell library 132 is provided to supply different classes of low-level circuits, i.e., standard cells, serving specific Boolean logic or sequential logic functions. In some embodiments, technology mapping of logic gates and registers to available cells in the standard cell libraries are conducted. Further, the design data or netlist data is offered to describe the functional relationship of the chip at a gate level. The standard cell library 132 may be provided by an IC designer, an IC manufacturing company, a computer-aided design (CAD) tool provider or any relevant third party. The standard cell library 132 also provides the parameters associated with each cell, such as the timing, power, voltage, and the like. In an embodiment, the netlist data is transformed from the gate-level view to a transistor-level view. In an embodiment, when the library is provided or updated (as will be described in subsequent paragraphs herein) and incorporated into the CAD tool, the IC designer can improve the updated library by identifying violations of the design rule (e.g., timing violations) and revising the original netlist data in response to the identified violations.

Subsequently, the gate-level netlist data is verified at the pre-layout simulation stage 140. During the verification process of the pre-layout simulation stage 140, if some functions fail the verification in the simulation, the design flow 10 may be paused temporarily or may go back to the system design stage 110 or the logic design stage 120 for further modification. After the pre-layout simulation stage 140, the chip design has passed a preliminary verification and the front-end design process is completed. Next, a back-end physical design process is conducted.

During the placement and routing stage 150, a physical architecture representing the chip, determined during the front-end process, is implemented. The layout development involves a placement operation and a routing operation in sequence. Detailed structures and associated geometries for the components of the chip are determined in the placement operation. Interconnects among different components are routed subsequent to the placement operation. Both placement and routing operations are performed to meet the requirement of a design rule check (DRC) deck so that the manufacturing constraints of the chip are fulfilled. In an embodiment, a clock tree synthesis operation is performed at the placement and routing stage for a digital circuit in which clock generators and circuits are incorporated into the design. In an embodiment, a post-routing operation is performed subsequent to the preliminary routing operation in order to resolve timing issues discovered during the preliminary routing operation. Once the placement and routing stage 150 is completed, a placed-and-routed layout is created and a netlist along with data on placement and routing is generated accordingly.

During the parameter extraction stage 160, a layout parameter extraction (LPE) operation is conducted to derive layout-dependent parameters, such as parasitic resistance and capacitance, based on the layout developed in the placement and routing stage 150. Subsequently, a post-layout netlist data, which includes the layout-dependent parameters, is generated.

During the post-layout simulation stage 170, a physical verification is performed, taking into consideration the parameters acquired in previous stages. A simulation of transistor-level behavior is conducted to examine whether the chip performance derived by the post-layout netlist meets the required system specifications. In some embodiments, the post-layout simulation is performed to minimize probability of electrical issues or layout difficulties during the chip manufacturing process. In an embodiment, the standard cell library 132 is provided not only to the operations in stage 130, but also to the operations in stages 140, 150, 160 and 170 so that the electrical or geometric parameters of cells and other features listed in the standard cell library 132 can be leveraged to emulate the real-world performance of the circuits throughout the design phase.

Next, in stage 180, it is determined whether the post-layout netlist meets the design specifications. If the result of the post-layout simulation is unfavorable, the design flow 10 loops back to previous stages for tuning functionalities or structures. For example, the design flow 10 may loop back to stage 150 where the layout is re-developed to resolve issues from a physical perspective. Alternatively, the design flow 10 may retreat to an earlier stage 110 or 120 to recast the chip design from a functional level in case the problems cannot be resolved within the back-end process.

If the post-layout netlist passes the verification, the circuit design is accepted and then signed off accordingly. The chip is manufactured according to the accepted post-layout netlist. In an embodiment, during stage 190, at least one photomask is generated based on the verified post-layout netlist in stage 170. A photomask is a patterned mask used to allow a portion of light to pass through while blocking other portions of the light in order to form a pattern of features on a light-sensitive layer, e.g., a photoresist layer, on a wafer. The photomask is used to transfer the patterns of the verified post-layout netlist onto wafers. In some embodiments, a multi-layer layout netlist may require a set of photomasks in which the feature pattern in each layer is established in the corresponding photomask. As a result, the patterns of the layout netlist formed on the photomasks are transferred to the light-sensitive layer through an exposure operation.

During stage 191, the circuit is fabricated on the wafer using the photomasks generated in stage 190. The fabrication may involve known semiconductor manufacturing operations, such as lithography, etching, deposition, and thermal operations. In some embodiments, a testing operation may be utilized in an intermediate or final phase of stage 191 to ensure physical and functional integrity of the fabricated circuit. In some embodiments, a singulation operation may be used to separate the circuit wafer into individual circuit dies. The fabrication of the circuit is thus completed.

The design flow 10 illustrated in FIG. 1 is exemplary. Modifications to the above-mentioned stages, such as change of order for the stages, partition of the stages, and deletion or addition of stages, are within the contemplated scope of the present disclosure.

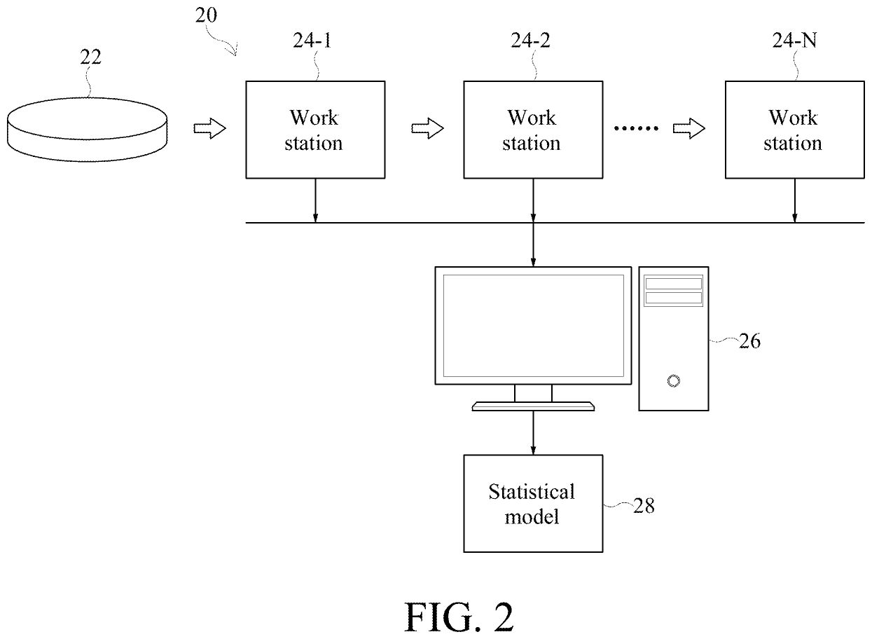

FIG. 2 is a schematic diagram of a comparative computing device 26 for generating a statistical model 28 based on measurements of process parameters in wafer fabrication. Referring to FIG. 2, a foundry for manufacturing wafers includes a plurality of workstations 24 (for example, 24-1, 24-2, . . . , 24-N, wherein N is a positive integer). Each workstation 24 is responsible for different manufacturing operations. For example, the workstation 24-1 is responsible for manufacturing a gate-oxide of a transistor, and the workstation 24-2 is responsible for dopant implant of a transistor.

In manufacturing a transistor, because of process variation, a 10o real thickness of a gate oxide of the transistor is inevitably different from an ideal (desired) thickness of a gate oxide. When a mass of wafers 22 are fabricated, a real thickness for each of (or most of) the fabricated wafers 22 are measured at the workstation 24-1, and provided to the computing device 26. A thickness of a gate oxide can be deemed as one type of process parameter. The computing device 26 collects a thickness of process parameters.

For reasons similar to the discussion of the thickness, when a mass of wafers 22 are fabricated, a real concentration of dopant for each of the fabricated wafers 22 are measured at the workstation 24-2, and provided to the computing device 26. A concentration of a dopant can be deemed as another type of process parameter. The computing device 26 collects a concentration of process parameters.

The computing device 26 generates the statistical model 28 by applying Monte Carlo methodology to the collected process parameters. An approach to generate the statistical model 28 using Monte Carlo methodology is well known, and therefore the detailed descriptions are omitted herein.

However, such statistical model 28 developed based on process parameters (such as the thickness, or the concentration mentioned above) is not reliable and not helpful for a circuit designer. A circuit simulation performed by a circuit designer using a tool such as HSPICE relies on a model associated with electrical parameters, instead of a model associated with process parameters. In addition, it is necessary to take a lot of time to perform the measurement to obtain the process parameters. Therefore, such procedure is not time efficient.

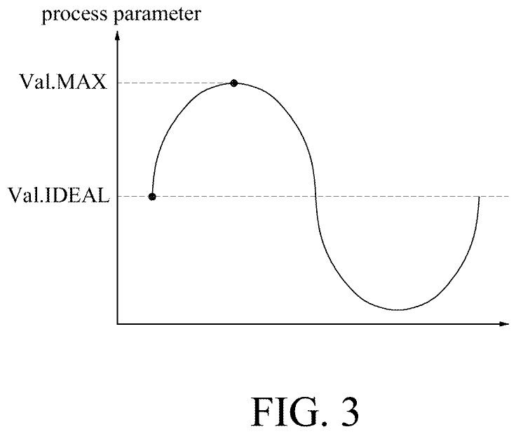

FIG. 3 is a schematic diagram illustrating process parameters mentioned in the exemplary example of FIG. 2. Referring to FIG. 3, for better understanding the process parameter, taking a thickness of a gate oxide of a transistor for instance, an ideal thickness of the gate oxide is denoted “Val.IDEAL.” Because of process variation, a real thickness is deviated from the ideal thickness Val.IDEAL, and a maximum value of the real thickness is denoted “Val.Max.” For all process parameters, the maximum value Val.Max is a worst case for its belonging process parameter.

As the workstation 24-1 provides a maximum value of a process parameter, each of the workstations 24 also provides a maximum value of its own process parameter. When a Monte Carlo methodology is used to develop a statistical model, such Monte Carlo methodology considers a situation in which each of the process parameters is the worst case (i.e., the maximum value) for a single transistor. However, in most cases, such situation would not occur on a transistor. The developed statistical model is too pessimistic. Such pessimistic statistical model may lead to difficulty in designing circuit for a circuit designer. Alternatively, a result of a Monte Carlo methodology is divergent and therefore is not acceptable by a circuit designer.

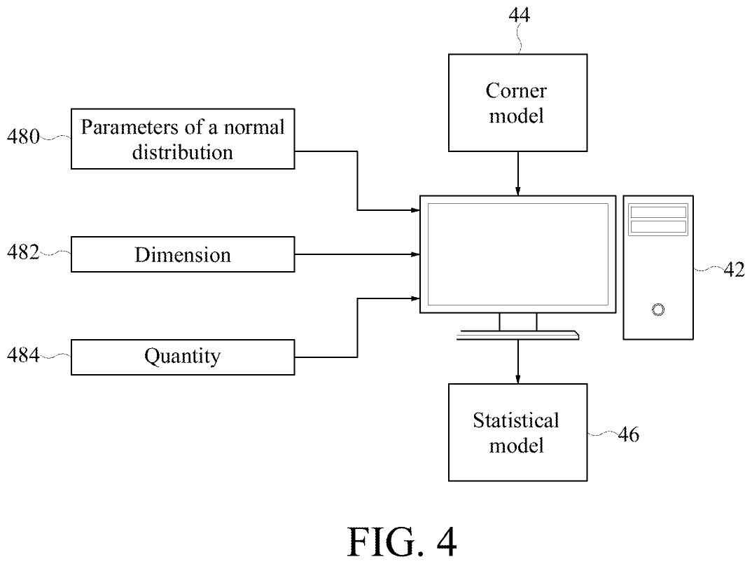

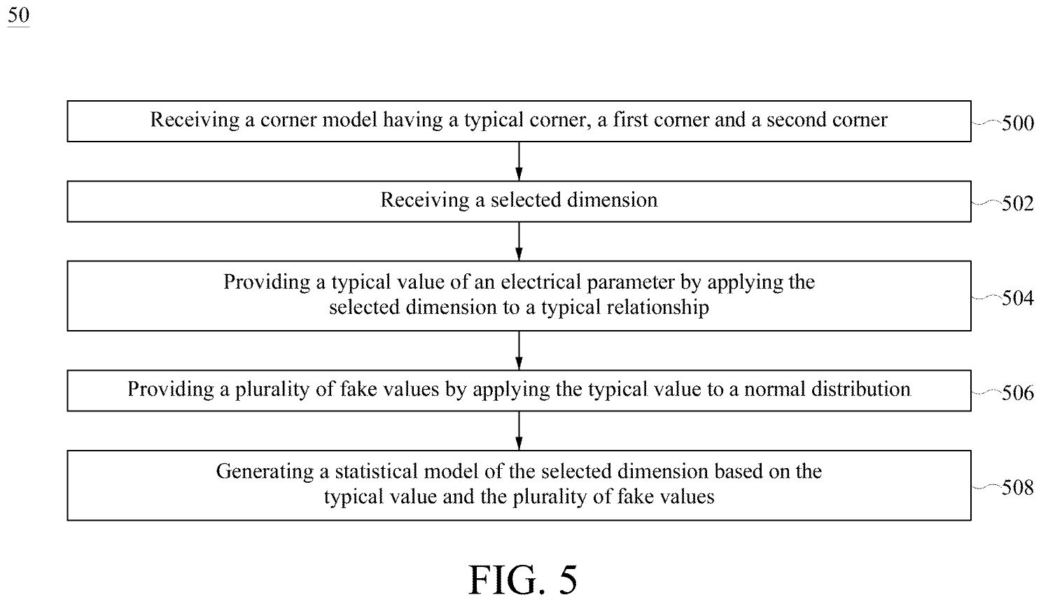

FIG. 4 is schematic diagram of a processing device 42 for developing a statistical model 46, in accordance with some embodiments of the present disclosure. Referring to FIG. 4, the processing device 42 functions to receive a corner model 44, and develop the statistical model 46 based on the corner model 44, which will be described in detail with reference to FIGS. 5 to 8. In the present disclosure, a model is not limited to a corner model. The processing device 42 is able to develop the statistical model 46 based on any models associated with an electrical parameter. The statistical model 46 can be used in the pre-layout simulation stage 140, the post-layout simulation stage 170, or other appropriate stages shown in FIG. 1.

In some embodiments, an operator selects a dimension 482. The processing device 42 functions to develop the statistical model 46 of the selected dimension 482. In some embodiments, the dimension 482 includes a length of a transistor. In some embodiments, the dimension 482 includes a width of a transistor. In some embodiments, the dimension 482 includes an aspect ratio of a transistor.

In some embodiments, an operator determines a desired quantity 482 of values for developing the statistical model 46. The processing device 42 functions to develop the statistical model 46 based on the predetermined quantity 482.

In some embodiment, an operator selects an electrical parameter 480 of interest of a corner model. The processing device 42 functions to develop the statistical model 46 associated with the electrical parameter 480.

In the present disclosure, since the statistical model 46 is developed based on the corner model 44 which is used in a circuit simulation by a circuit designer, the statistical model 46 based on the corner model 44 is relatively reliable and acceptable for a circuit designer. Moreover, it is no longer required to perform measurement to obtain a plurality of process parameters. As a result, it is time efficient.

FIG. 5 is a flowchart of a method 50, in accordance with some embodiments of the present disclosure. Referring to FIG. 5, the method 50 includes operations 500, 502, 504, 506 and 508.

The method 50 begins with operation 500, in which a corner model is received. The corner model includes a typical corner, a first corner and a second corner. In some embodiments, the typical corner includes a typical-to-typical (denoted TT) corner, the first corner includes a slow-to-slow (denoted SS) corner, and the second corner includes a fast-to-fast (denoted FF) corner. For better understanding the concept of the present disclosure, in the following discussion the TT corner, the SS corner and the FF corner are used to explain operation of the present disclosure.

The method 50 continues with operation 502, in which a selected dimension is received. In some embodiments, the selected dimension is a dimension of interest to a circuit designer. In some embodiments, the selected dimension ranges from a lower limit dimension to an upper limit dimension of a design rule of a semiconductor manufacturing process. For ease of understanding, in the following discussion, the selected dimension refers to the selected length.

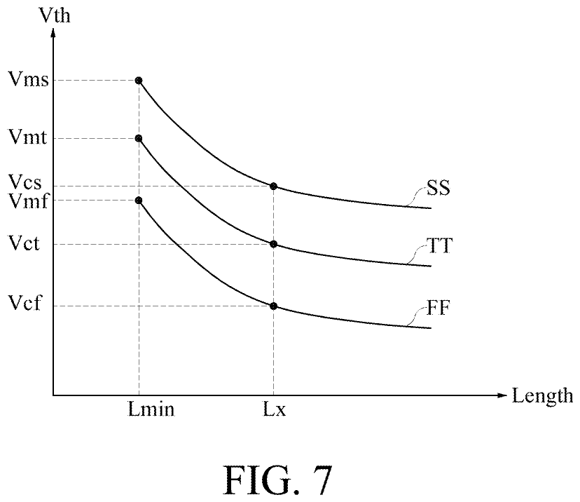

The method 50 proceeds to operation 504, in which a typical value of an electrical parameter is provided by applying the selected dimension to a typical relationship, wherein the corner model includes the typical relationship between a value of the electrical parameter and the selected dimension at a typical corner. For ease of understanding, in the following discussion, the electrical parameter refers to a threshold voltage Vth of a transistor with reference to FIG. 7.

FIG. 7 is a schematic diagram illustrating a relationship between the threshold voltage Vth and a length of a transistor at different corners, in accordance with some embodiments of the present disclosure. Referring to FIG. 7, a horizontal axis represents the length of a transistor, and a vertical axis represents the threshold voltage Vth of a transistor. Generally, electrical parameters are critical only at a minimum length Lmin, and it is necessarily to measure the electrical parameters at such minimum length Lmin. For example, the threshold voltage Vth is critical only at a minimum length Lmin and therefore is measured at such minimum length Lmin. Accordingly, a value Vms of the threshold voltage Vth at the SS corner, a value Vmt of the threshold voltage Vth at the TT corner and a value Vmf of the threshold voltage Vth at the FF corner are measured.

If it is desired to obtain a value of the threshold voltage Vth at a length other than the minimum length Lmin, for example, a length Lx, the value can be obtained according to an equation recorded in the corner model. Approaches to obtaining a value of the threshold voltage Vth at a specific length are well known. Therefore, the detailed descriptions are omitted herein.

The embodiment of FIG. 7 serves only as an example to explain how to obtain a value of the threshold voltage Vth at a predetermined length. Based on the similar approaches, a value of the threshold voltage Vth at a selected aspect ratio can be obtained.

Referring back to operation 504 with reference to FIG. 7, according to the above assumption, a typical value Vct of the threshold voltage Vth is provided by applying the selected length Lx to a typical relationship.

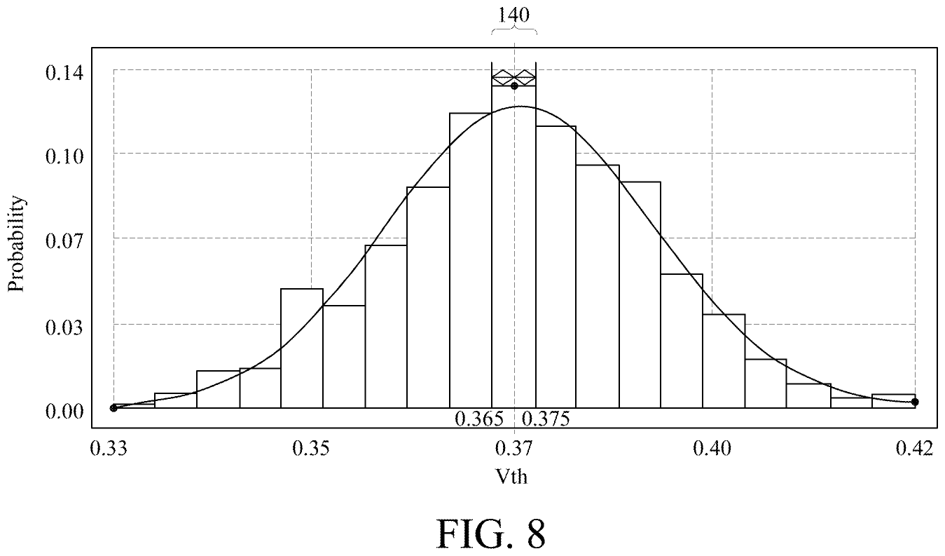

The method 50 proceeds to operation 506 with reference to FIG. 8, in which a plurality of fake values is provided by applying the typical value to a normal distribution.

FIG. 8 is a schematic diagram of a normal distribution for generating a plurality of fake values, in accordance with some embodiments of the present disclosure. Referring to FIG. 8, a horizontal axis represents the threshold voltage Vth; and a vertical axis represents probability.

It is assumed that the typical value Vct at the selected length Lx is 0.37 volts (V). The typical value Vct of 0.37 V is set as a center value of the normal distribution. According to the normal distribution, a probability at a center portion, including the typical value Vct of 0.37 V, of the normal distribution is 0.14. If the predetermined quantity of values for generating the statistical model 46 is 1000, then there are 140 values at the center portion. The 140 values, for example, range from about 0.365 V to about 0.375 V. Such 140 values are the fake values. The fake values are not obtained from measurement of silicon wafer, and are obtained according to mathematical method of the normal distribution.

The method 50 proceeds to operation 508, in which the statistical model of the selected dimension is generated based on the typical value and the plurality of fake values.

An approach to adjust a shape of the normal distribution is well known. The detailed descriptions are omitted herein. By adjusting a value of parameters, such as sigma, of the normal distribution, probability at, for example, the center portion, might be changed. The fake values would be changed accordingly. Therefore, a method of the present disclosure to develop the statistical model 46 is flexible.

The method 50 is merely an example, and is not intended to limit the present disclosure beyond what is explicitly recited in the claims. Additional operations can be provided before, during, and after the method 50, and some operations described can be replaced, eliminated, or moved around for additional embodiments of the method.

In the present disclosure, the normal distribution is applied. However, the present disclosure is not limited to the normal distribution. Any distribution can be applied to the present disclosure, depending on a preference of a circuit designer.

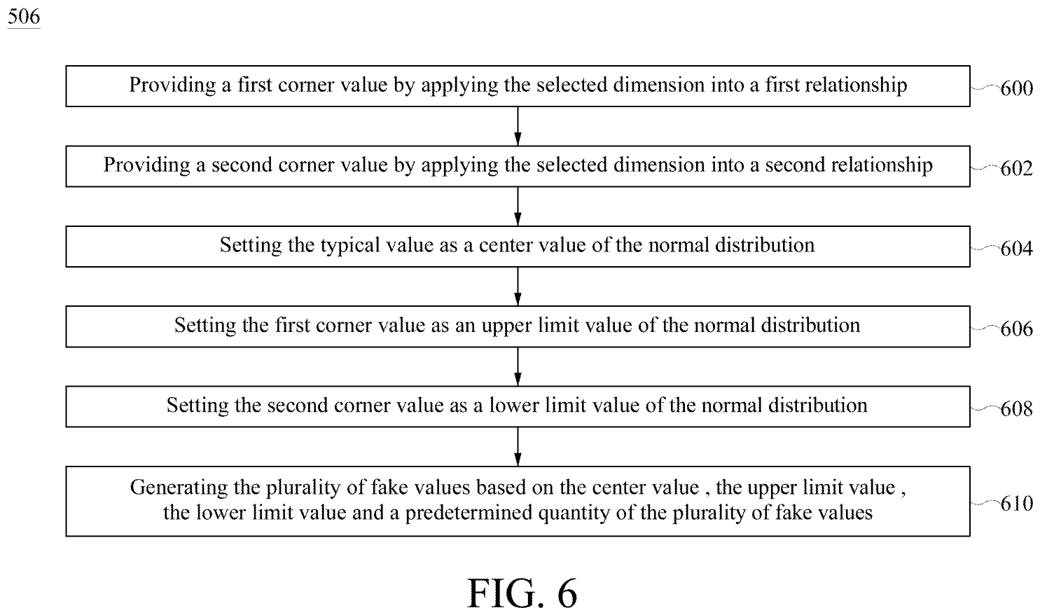

FIG. 6 is a flowchart of operation 506 shown in FIG. 5, in accordance with some embodiments of the present disclosure. Referring to FIG. 6, operation 506 includes operations 600, 602, 604, 606, 608 and 610.

Operation 506 begins with operation 600, in which a first corner value is generated by applying the selected dimension to a first relationship. The corner model further includes the first relationship between a value of an electrical parameter and the selected dimension at a first corner. For example, referring to FIG. 7, the first corner value Vcs is generated by applying the selected length Lx to the first relationship associated with the SS corner.

Operation 506 proceeds to operation 602, in which a second corner value is generated by applying the selected dimension to a second relationship. The corner model further includes the second relationship between a value of the electrical parameter and the selected dimension at a second corner. For example, referring to FIG. 7, the second corner value Vcf is generated by applying the selected length Lx to the second relationship associated with the FF corner.

Operation 506 continues with operation 604, in which the typical value is set as a center value of the normal distribution. For example, referring to FIG. 8, the typical value 0.37 V of the typical value Vct is set as a center value of the normal distribution.

Operation 506 proceeds to operation 606, in which the first corner value is set as an upper limit value of the normal distribution. For example, referring to FIG. 8, the first corner value Vcs of 0.42 V is set as an upper limit value.

Operation 506 continues with operation 608, in which the second corner value is set as a lower limit value of the normal distribution. For example, referring to FIG. 8, the second corner value Vcf of 0.33 V is set as a lower limit value.

Operation 506 proceeds to operation 610, in which the plurality of fake values are generated based on the center value, the upper limit value, the lower limit value and a predetermined quantity of the plurality of fake values.

The method 506 is merely an example, and is not intended to limit the present disclosure beyond what is explicitly recited in the claims. Additional operations can be provided before, during, and after the method 506, and some operations described can be replaced, eliminated, or moved around for additional embodiments of the method.

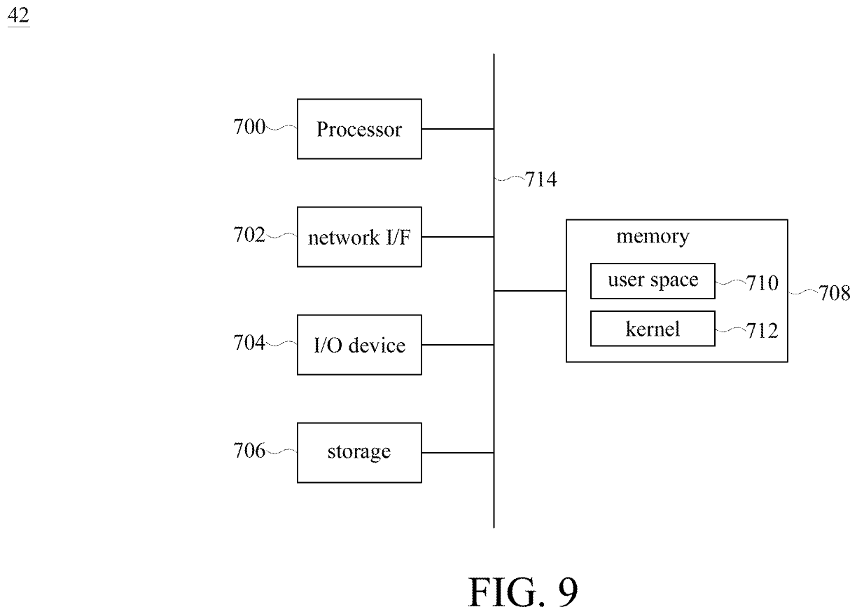

FIG. 9 is a block diagram of the processing device 42 of FIG. 4 in accordance with some embodiments of the present disclosure. One or more of the tools, systems, or operations described with respect to FIGS. 4 to 8 are realized in some embodiments by one or more computer systems. The processing device 42 comprises a processor 700, a memory 708, a network interface (I/F) 702, a storage 706, and an input/output (I/O) device 704 communicatively coupled via a bus 714 or other interconnection communication mechanism.

The memory 708 comprises, in some embodiments, a random access memory (RAM), other dynamic storage device, read-only memory (ROM), or other static storage device, coupled to the bus 714 for storing data or instructions to be executed by the processor 700, e.g., kernel 712, user space 710, portions of the kernel or the user space, and components thereof. The memory 708 is also used, in some embodiments, for storing temporary variables or other intermediate information during execution of instructions to be executed by the processor 700.

In some embodiments, a storage device 706, such as a magnetic disk or optical disk, is coupled to the bus 714 for storing data or instructions, e.g., kernel 712, user space 710, etc. The I/O device 704 comprises an input device, an output device, or a combined input/output device for enabling user interaction with the system. An input device comprises, for example, a keyboard, keypad, mouse, trackball, trackpad, or cursor direction keys for communicating information and commands to the processor 700. An output device comprises, for example, a display, a printer, a voice synthesizer, etc. for communicating information to a user.

In some embodiments, one or more operations or functionality of the tools or systems described with respect to FIGS. 4 to 8 are realized by the processor 700, which is programmed for performing such operations and functionality. One or more of the memory 708, the I/F 702, the storage 706, the I/O device 704, the hardware components 718, and the bus 714 are operable to receive instructions, data, design rules, netlists, layouts, models and other parameters for processing by the processor 700.

In some embodiments, one or more of the operations, functionality of the tools, and systems described with respect to FIGS. 4 to 8 are implemented by specifically configured hardware (e.g., by one or more application specific integrated circuits (ASICs) which are included) separate from or in lieu of the processor 700. Some embodiments incorporate more than one of the described operations or functionality in a single ASIC.

In some embodiments, the operations and functionality are realized as functions of a program stored in a non-transitory computer readable recording medium. Examples of a non-transitory computer readable recording medium include, but are not limited to, external/removable or internal/built-in storage or memory unit, e.g., one or more of an optical disk, such as a DVD, a magnetic disk, such as a hard disk, a semiconductor memory, such as a ROM, a RAM, a memory card, and the like.

In the present disclosure, since the statistical model 46 is developed based on the corner model 44 which is used in a circuit simulation by a circuit designer, the statistical model 46 based on the corner model 44 is relatively reliable and acceptable for a circuit designer. Moreover, it is no longer required to perform measurement to obtain a plurality of process parameters. As a result, it is time efficient.

One embodiment of the present disclosure provides a method. The method includes receiving a corner model; receiving a selected dimension of a transistor; and generating a statistical model of the selected dimension based on the corner model.

Another embodiment of the present disclosure provides a system for developing a statistical model for circuit simulation. The system includes one or more processing units. The one or more processing units are configured for: receiving a corner model; receiving a selected dimension of a transistor; and generating a statistical model of the selected dimension based on the corner model.

Another embodiment of the present disclosure provides an article of manufacture. The article of manufacture includes at least one non-transitory machine-readable storage medium having computer readable program code logic tangibly embodied therein to execute a machine instruction in a processing unit for developing a statistical model for a circuit simulation. The computer readable program code logic, when executing, performing the following steps: receiving a corner model; receiving a selected dimension of a transistor; and generating a statistical model of the selected dimension based on the corner model.

Moreover, the scope of the present application is not intended to be limited to the particular embodiments of the process, machine, manufacture, and composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a corner model;
receiving a selected dimension of a transistor; and
generating a statistical model of the selected dimension based on the corner model.

2. The method of claim 1, wherein the corner model includes a typical relationship between a value of an electrical parameter and the selected dimension at a typical corner, the method further comprising:
providing a typical value of an electrical parameter by applying the selected dimension to the typical relationship; and
providing a plurality of fake values by applying the typical value to a normal distribution,
wherein the generation of the statistical model includes:
generating the statistical model based on the typical value and the plurality of fake values.

3. The method of claim 2, wherein the corner model further includes a first relationship between a value of the electrical parameter and the selected dimension at a first corner, and a second relationship between a value of the electrical parameter and the selected dimension at a second corner, the method further comprising:
providing a first corner value by applying the selected dimension to the first relationship; and
providing a second corner value by applying the selected dimension to the second relationship,
wherein the generation of the plurality of fake values includes:
generating the plurality of fake values based on the typical value, the first corner value and the second corner value.

4. The method of claim 3, wherein the plurality of fake values are between the first corner value and the second corner value.

5. The method of claim 3, further comprising:
setting the typical value as a center value of the normal distribution;
setting the first corner value as an upper limit value of the normal distribution; and
setting the second corner value as a lower limit value of the normal distribution,
wherein the generation of the plurality of fake values includes:
generating the plurality of fake values based on the upper limit value, the lower limit value and the center value.

6. The method of claim 5, further comprising:
receiving a predetermined quantity of the plurality of fake values,
wherein the generation of the plurality of fake values includes:
generating the plurality of fake values based on the upper limit value, the lower limit value, the center value and the predetermined quantity.

7. The method of claim 3, wherein the typical corner includes a typical-to-typical corner, the first corner includes a slow-to-slow corner, and the second corner includes a fast-to-fast corner.

8. A system for developing a statistical model for circuit simulation, the system comprising:
one or more processing units;
the one or more processing units configured for:
receiving a corner model;
receiving a selected dimension of a transistor; and
generating a statistical model of the selected dimension based on the corner model.

9. The system of claim 8, wherein the corner model includes a typical relationship between a value of an electrical parameter and the selected dimension at a typical corner, the one or more processing units further configured for:
providing a typical value of an electrical parameter by applying the selected dimension to the typical relationship;
providing a plurality of fake values by applying the typical value to a normal distribution, and
generating the statistical model based on the typical value and the plurality of fake values.

10. The system of claim 9, wherein the corner model further includes a first relationship between a value of the electrical parameter and the selected dimension at a first corner, and a second relationship between a value of the electrical parameter and the selected dimension at a second corner, the one or more processing units further configured for:
providing a first corner value by applying the selected dimension to the first relationship;
providing a second corner value by applying the selected dimension to the second relationship; and
generating the plurality of fake values based on the typical value, the first corner value and the second corner value.

11. The system of claim 10, wherein the plurality of fake values are between the first corner value and the second corner value.

12. The system of claim 10, wherein the one or more processing units further are configured for:
setting the typical value as a center value of the normal distribution;
setting the first corner value as an upper limit value of the normal distribution;
setting the second corner value as a lower limit value of the normal distribution; and
generating the plurality of fake values based on the upper limit value, the lower limit value and the center value.

13. The system of claim 12, wherein the one or more processing units are further configured for:
receiving a predetermined quantity of the plurality of fake values; and
generating the plurality of fake values based on the upper limit value, the lower limit value, the center value and the predetermined quantity.

14. The system of claim 10, wherein the typical corner includes a typical-to-typical corner, the first corner includes a slow-to-slow corner, and the second corner includes a fast-to-fast corner.

15. An article of manufacture, comprising:
at least one non-transitory machine-readable storage medium having computer readable program code logic tangibly embodied therein to execute a machine instruction in a processing unit for developing a statistical model for a circuit simulation, wherein the computer readable program code logic, when executing, performs the following steps:
receiving a corner model;
receiving a selected dimension of a transistor; and
generating a statistical model of the selected dimension based on the corner model.

16. The article of claim 15, wherein the corner model includes a typical relationship between a value of an electrical parameter and the selected dimension at a typical corner, and the computer readable program code logic, when executing, further performs the following steps:
providing a typical value of an electrical parameter by applying the selected dimension to the typical relationship;
providing a plurality of fake values by applying the typical value to a normal distribution; and
generating the statistical model based on the typical value and the plurality of fake values.

17. The article of claim 16, wherein the corner model further includes a first relationship between a value of the electrical parameter and the selected dimension at a first corner, and a second relationship between a value of the electrical parameter and the selected dimension at a second corner, and the computer readable program code logic, when executing, further performs the following steps:
providing a first corner value by applying the selected dimension to the first relationship;
providing a second corner value by applying the selected dimension to the second relationship; and
generating the plurality of fake values based on the typical value, the first corner value and the second corner value.

18. The article of claim 17, wherein the plurality of fake values is between the first corner value and the second corner value.

19. The article of claim 17, wherein the computer readable program code logic, when executing, further performs the following steps:
setting the typical value as a center value of the normal distribution;
setting the first corner value as an upper limit value of the normal distribution;
setting the second corner value as a lower limit value of the normal distribution; and
generating the plurality of fake values based on the upper limit value, the lower limit value and the center value.

20. The article of claim 19, wherein the computer readable program code logic, when executing, further performs the following steps:
receiving a predetermined quantity of the plurality of fake values; and
generating the plurality of fake values based on the upper limit value, the lower limit value, the center value and the predetermined quantity.
